(19) United States
(12) Patent Application Publication
(10) Pub. No.: US 2018/0170582 A1
(43) Pub. Date: Jun. 21, 2018

(54) SYSTEM FOR SUPPLYING AN IGNITER WITH PROPELLANT

(71) Applicant: SNECMA, Paris (FR)

(72) Inventor: Davide DURI, Vernon (FR)

(73) Assignee: ARIANEGROUP SAS, Paris (FR)

(21) Appl. No.: 15/735,782

(22) PCT Filed: Jun. 9, 2016
(86) PCT No.: PCT/FR2016/051380

§ 371 Date: Dec. 12, 2017

(30) Foreign Application Priority Data
Jun. 18, 2015 (FR) 1501275

(51) Int. Cl. B64G 1/40; F02K 9/44; F22B 1/04; F22B 27/14

(52) U.S. Cl. CPC B64G 1/402; F22B 27/14; F22B 1/04; F02K 9/44

(57) ABSTRACT

A system (100) for feeding propellant to an igniter, the system comprising:
a tank (10) presenting an admission (11) and an outlet (12);
a liquid propellant feed line connected to the admission (11) of the tank (10); and
a propellant outlet line connecting an outlet (12) of the tank (10) to an igniter (40);
the system being characterized in that said tank (10) presents an inside volume filled with heat storage spheres (20), said storage spheres (20) being adapted to store heat and to transmit it to a fluid passing through said tank (10), in such a manner as to vaporize a liquid propellant passing through said tank (10).

### GENERAL TECHNICAL FIELD

The present invention relates to the field of ignition systems for cryogenic engines, and more precisely of systems for feeding gaseous propellant to an ignition system of such a cryogenic engine.

### STATE OF THE ART

Ignition systems for cryogenic engines need to be fed with gaseous propellants in order to operate, and the flow rate of gaseous propellants needs to be well controlled in order to ensure ignition.

The liquid propellant used for feeding the ignition system is typically taken from the tank of the propulsion stage of the associated engine throughout the duration of the ignition sequence.

The liquid is taken at the pressure of the tank, and the propellant is then vaporized in order to feed the ignition system.

Unfortunately, it is complex to vaporize the propellant, and this can have a negative impact on the performance of the system, in particular because of the thermal inertia of the feeding circuit, which can prevent the propellant vaporizing completely.

At present, several solutions have been proposed for improving ignition performance:
so-called “passive” solutions in which the propellant is stored at high pressure in a set of cylinders, which cylinders are associated with a filling, control, and expansion circuit, or indeed in which the propellant is vaporized by convective heat exchange with the walls of the igniter feeding circuit; and
so-called “active” solutions, in which the propellant is vaporized by heating performed using autogenous heat sources fed with the propellant of the tanks.

Nevertheless, each of those various solutions presents drawbacks that are found to be very detrimental.

Passive systems using high-pressure propellant storage cylinders present drawbacks in terms of weight.

Furthermore, passive systems operating by heat exchange are very complex to dimension suitably, in particular because of the low heat-exchange coefficient in forced convection and with film flow.

Active systems that heat the propellant require heat exchangers and an associated combustion chamber, which are likewise detrimental in terms of weight.

Furthermore, for active systems, not only is it necessary to have an independent igniter, which once more raises the same problems, but combustion during transient stages is also very difficult to control.

### SUMMARY OF THE INVENTION

The present invention seeks to respond to those problems, at least in part, and thus proposes a system for feeding propellant to an igniter, the system comprising:
a tank presenting an admission and an outlet;
a liquid propellant feed line connected to the admission of the tank; and
a propellant outlet line connecting an outlet of the tank to an igniter;

the system being characterized in that said tank presents an inside volume filled with heat storage spheres, said storage spheres being adapted to store heat and to transmit it to a fluid passing through said tank, in such a manner as to vaporize a liquid propellant passing through said tank.

Typically, the inside volume is defined by peripheral walls of the tank, by an upstream plate, and by a downstream plate, one of the upstream and downstream plates being subjected to a thrust force towards the other one of the upstream and downstream plates so as to compact the storage spheres contained in the inside volume.

By way of example, said storage spheres are made of polyamides and/or of polytetrafluoroethylene.

The system may also comprise a system for injecting hot gas into the tank so as to store heat energy in the storage spheres.

By way of example, said hot gas is helium.

The invention also provides a method of vaporizing a propellant feeding an igniter, wherein:
storing heat in a set of storage spheres contained in a tank; and
feeding an igniter with propellant via said tank, in such a manner that the propellant reaching the igniter previously passes through the tank and is vaporized by heat exchange with the storage spheres.

Typically, said storage spheres are kept compressed in the inside volume of the tank between two plates arranged in the tank and subjected to a thrust force. Both plates are pierced, such that each of them presents holes allowing the fluid to pass through the inside of the tank, while ensuring that the storage spheres are maintained in the inside volume.

The holes formed in the plates are thus of a diameter that is smaller than the diameter of the storage spheres.

In a particular embodiment, heat is stored in the storage spheres by injecting a hot gas into the tank, e.g. helium.

### SUMMARY OF THE FIGURES

Other characteristics, objects, and advantages of the invention appear from the following description, which is purely illustrative and non-limiting, and which should be read with reference to the accompanying figures, in which:

FIG. 1 is a diagram of a system according to an aspect of the invention; and

FIG. 2 is a diagram showing a method according to an aspect of the invention.

### DETAILED DESCRIPTION

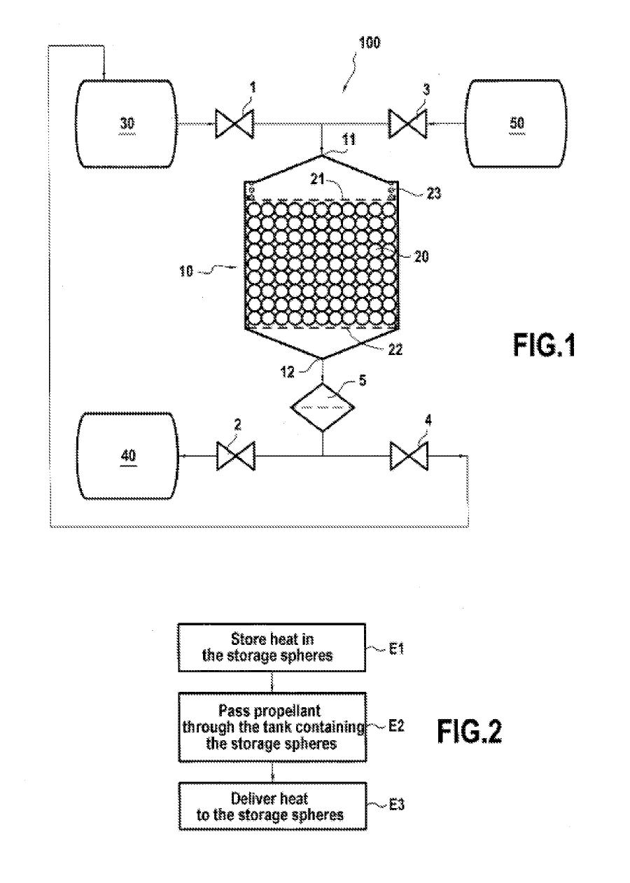

FIG. 1 is a diagram showing an example of a propellant feed system 100 according to an aspect of the invention.

The illustrated system 100 comprises a tank 10 having an admission 11 and an outlet 12, and defined by walls.

The outlet 12 of the tank 10 is typically provided with a filter 5.

The admission 11 of the tank 10 is connected to a liquid propellant tank 30 via a propellant admission valve 1.

The outlet 12 of the tank 12 is connected to an igniter 40 via an ignition valve 2.

The tank 10 defines an inside volume, having at least a portion thereof filled with storage spheres 20.

By way of example, storage spheres 20 are made of polyamides and/or polytetrafluoroethylene (PTFE). PTFE is particularly advantageous because of its ratio of weight to heat transfer capacity, and because of its chemical compatibility with the propellants commonly used, and in particular with oxygen.

In the embodiment shown, the inside volume filled with storage spheres 20 is defined both by the peripheral walls of the tank and also by an upstream plate 21 and a downstream plate 22.

In the example shown, the downstream plate 22 is stationary, while the upstream plate 21 is coupled to a spring 23 that exerts a thrust force on the upstream plate 21 tending to move it towards the downstream plate 22.

In a variant, it is the downstream plate 22 that may be coupled to a spring tending to urge it towards the upstream plate 21, while the upstream plate is stationary, or indeed both the upstream and downstream plates 21, 22 could be coupled with respective springs tending to push them towards each other.

The upstream and downstream plates 21, 22 are pierced, so each of them presents holes allowing fluid to pass through the tank 10, while also retaining the storage spheres 20 in the inside volume of the tank 10.

The holes formed in the upstream and downstream plates 21, 22 are thus of a diameter smaller than the diameter of the storage spheres 20.

The storage spheres 20 are thus compacted in the inside volume between the upstream and downstream plates 21, 22.

The inside volume of the tank 10 filled with storage spheres 20 is configured so that a fluid going from the admission 11 to the outlet 12 of the tank 10 necessarily passes through the inside volume of the tank 10.

The storage spheres 20 are configured in such a manner as to store heat, and thus transfer heat to a fluid passing through the inside volume of the tank 10. They are heated beforehand in order to store the desired energy.

Thus, when the propellant admission valve 1 and the ignition valve 2 are open, liquid propellant coming from the liquid propellant tank 30 reaches the tank 10 via its admission 11, then passes through the inside volume of the tank filled with storage spheres 20, prior to leaving via the outlet 12 of the tank so as to reach the igniter 40.

When the liquid propellant passes through the inside volume of the tank 10 filled with storage spheres 20, the spheres transfer heat to the liquid propellant, thereby transferring the heat energy stored in the storage spheres 20 to the propellant.

The storage spheres 20 are calibrated so that the heat energy that is stored therein is sufficient for vaporizing the liquid propellant as it passes through the tank 10, such that the igniter 10 is fed with gaseous propellant.

The system 100 may include a system for injecting hot gas into the tank 10 so as to charge or recharge the storage spheres 20 with heat energy.

In the embodiment shown in FIG. 1, the admission 11 of the tank 10 is thus connected to a hot gas tank 50 via a heater valve 3.

The outlet 12 of the tank 10 is then also connected to a discharge line via a leakage valve 4, through which the hot gas is discharged after it has passed through the tank 10.

The hot gas contained in the hot gas tank 50 may be helium, for example. The helium is then discharged into the gas head space of the liquid propellant tank 30, as shown in FIG. 1.

By way of example, the hot gas injection system is used after the igniter 40 has been put into operation, in order to recharge the storage spheres 20 for the purpose of a subsequent ignition.

FIG. 2 is a diagram showing the method that can be implemented by means of the system shown in FIG. 1.

During a first step E1, heat is stored in a set of storage spheres 20 contained in a tank 10 by causing a heat-conveying fluid to flow through the system.

Thereafter, once the desired heat energy has been stored in the storage spheres, it is then possible, during a second step E2, to feed an igniter with propellant via said tank 10, the propellant being taken from a liquid propellant tank 30, in such a manner that the propellant reaching the igniter 40 has previously passed through the tank 10 and been vaporized by exchanging heat with the storage spheres 20.

After this second step E2, it is then possible during a third step E3 to recharge the storage spheres by injecting a hot gas such as helium into the tank.

The proposed system thus presents operation that is cyclical, based on a succession of steps of vaporizing propellant until the device is discharged, and steps of recharging the device.

Such cyclical operation is advantageous compared with continuous operation in that it thus makes it possible to use a heat-conveying fluid that can flow through the system in order to recharge it, unlike systems that operate continuously and that require a specific recharging system, e.g. by using induction heating.

The use of storage spheres 20 is particularly advantageous, in particular because of the very large heat exchange area they create.

Furthermore, the use of storage spheres 20 gives considerable flexibility in calibrating the system, in particular by varying the number of storage spheres 20 and their dimensions, thus making it possible in particular to modify the energy storage and restitution capacity of the storage spheres 20, and also the flow and head loss properties generated by the storage spheres 20.

Furthermore, compared with conventional passive or active systems, such a system 100 presents smaller weight.

In addition, the heat exchanger formed by the storage spheres 20 also serves to homogenize the stream passing through the tank 10.

The proposed system and method thus make it possible to make use of a ball heat exchanger for vaporizing and homogenizing a cryogenic fluid, in particular in the context of space applications.

1. A system for feeding propellant to an igniter, the system comprising:
a tank presenting an admission and an outlet;
a liquid propellant feed line connected to the admission of the tank; and
a propellant outlet line connecting the outlet of the tank to an igniter; wherein said tank presents an inside volume filled with heat storage spheres, said storage spheres being adapted successively to store heat delivered by a heat-conveying fluid, and to transmit it to a fluid passing through said tank, in such a manner as to vaporize a liquid propellant passing through said tank.

2. A system according to claim 1, wherein the inside volume is defined by peripheral walls of the tank, by an upstream plate, and by a downstream plate, one of the upstream and downstream plates being subjected to a thrust force towards the other one of the upstream and downstream plates so as to compact the storage spheres contained in the inside volume, said plates being pierced, each thus presenting holes each of a diameter smaller than the diameter of the storage spheres.

3. A system according to claim 1, wherein said storage spheres are made of polyamides and/or of polytetrafluoroethylene.

4. A system according to claim 1, further comprising a system for injecting hot gas into the tank so as to store heat energy in the storage spheres.

5. A system according to claim 4, wherein said hot gas is helium.

6. A method of vaporizing a liquid propellant feeding an igniter by means of a system for feeding propellant to an igniter, the system comprising:
a tank presenting an admission and an outlet;
a liquid propellant feed line connected to the admission of the tank; and
a propellant outlet line connecting the outlet of the tank to an igniter;
wherein said tank presents an inside volume filled with heat storage spheres, said storage spheres being adapted successively to store heat delivered by a heat-conveying fluid, and to transmit it to a fluid passing through said tank, in such a manner as to vaporize a liquid propellant passing through said tank, and the method comprising in succession:
storing heat in the storage spheres contained in the tank; and then
feeding the igniter with propellant via said tank in such a manner that the propellant reaching the igniter previously passes through the tank and is vaporized by exchanging heat with the storage spheres.

7. A method according to claim 6, wherein said storage spheres are kept compressed in the inside volume of the tank between two plates arranged in the tank and subjected to a thrust force.

8. A method according to claim 6, wherein heat is stored in the storage spheres by injecting a hot gas into the tank.

9. A method according to claim 8, wherein said hot gas is helium.
